(19) United States
(12) Patent Application Publication
(10) Pub. No.: US 2013/0047496 A1
(43) Pub. Date: Feb. 28, 2013

(54) Pest control system and method

(71) Applicant: Joseph F. Azzarello, JR., Metairie, LA (US)

(72) Inventor: Joseph F. Azzarello, JR., Metairie, LA (US)

(21) Appl. No.: 13/199,344

(22) Filed: Aug. 26, 2011

(51) Int. Cl. A01M 1/20

(52) U.S. Cl. 43/131

(57) ABSTRACT

A system and method of monitoring and controlling subterranean above-ground foraging pests in a predetermined location provides for the use of a hollow body having an open top and an open bottom. A plurality of supporting legs extends downwardly from a bottom edge of the hollow body. Once embedded into the soil, the legs allow the bottom edge to be at ground level. A substance attractive to the pests as a food source is deposited directly on the ground within the cavity defined by the hollow body. A lid is locked to the open top and the system is monitored for a pre-determined period of time. If consumption of the food material is detected, it is substituted with a bait material containing poisonous substance. The pests consume the bait and carry the poison to the subterranean location.

### BACKGROUND OF THE INVENTION

This invention generally relates to a pest control system, and more particularly to a system that allows to attract and destroy colonies of cellulose-eating pests, such as termites.

Many pests, such as termites, are serious threats throughout much of the world to structures or other objects containing wood or other cellulose containing components because these pests consume cellulose for nutrition. Subterranean termites, which typically dwell in the soil, often form large colonies. Members of the colony forage for food and thus burrow galleries or passageways in the soil outwardly from the nest. Portions of the food located by the foraging termites are returned to the nest. Termites are also known to possess means for communicating the location of a food source to other termites within the colony.

Coptotermes formosanus is an invasive species of termite; it is often nicknamed the super-termite because of its destructive habits. This is because of the large size of its colonies, and the termites' ability to consume wood at a rapid rate. A single colony may contain several million individuals (compared with several hundred thousand termites for other subterranean termite species) that forage up to 300 feet (100 m) in soil. A mature Formosan colony can consume as much as 13 ounces (400 g) of wood a day and severely damage a structure in as little as three months. Because of its population size and foraging range, the presence of a colony poses serious threats to nearby structures. Formosan subterranean termites infest a wide variety of structures (including boats and high-rise structures) and can damage trees. In the United States, along with another species, Coptotermes gestroi, also introduced from Southeast Asia, are responsible for tremendous damage to property resulting in large treatment and repair costs.

Another highly destructive type of termites is Reticulitermes flavipes, the eastern subterranean termite, which is the most common termite found in North America. These termites feed on cellulose material such as the structural wood in buildings, wooden fixtures, paper, books and cotton. A mature colony can range from 20,000 workers to as high as 5 million workers and the queen of the colony lays 5,000 to 10,000 eggs per year. Both Coptotermes formosanus and Reticulitermes flavipes also feed on cellulose material above ground. In many instances, Coptotermes formosanus will build above-ground colonies in the wood they are consuming. These colonies can be as large as subterranean colonies and are associated with above-ground moisture such as rain, outdoor plant material or moisture leaks in man-made structures. In such cases, the Formosan termites demonstrate a definite preference to feeding and colonizing at grade and above ground.

Many pest control systems are known and formed in a wide variety of configurations to monitor and eradicate the pests. One type of popular termite control system, for example, utilizes a monitoring bait food source that is placed below grade; the food source attracts the termites, which begin feeding from the device. The bait has a toxic material, which once consumed, helps in the elimination or suppression of the entire termite colony. However, such systems may be ineffective against the termites that forage above ground.

The present invention contemplates elimination of drawbacks associated with conventional pest control systems and provision of a pest control system designed to eradicate above-ground colonies of cellulose-eating insects.

### SUMMARY OF THE INVENTION

It is, therefore, an object of the present invention to provide a pest-control system that is designed to eradicate above-ground foraging pests.

It is another object of the invention to provide a pest control system and method of eradicating above-ground foraging termites.

These and other objects of the invention are achieved through a provision of a system and method for monitoring and controlling above-ground foraging subterranean pests such as termites. The system comprises a hollow body having an inner wall, an open top, an open bottom, a top edge, and a bottom edge defining an interior cavity. A plurality of spear-shaped supporting legs are secured to the bottom edge; the supporting legs are configured to be embedded into ground in a pre-determined location to a depth sufficient to position the bottom edge of the body at ground level. The pre-determined location is selected where presence of the pests is suspected or needs to be monitored.

A substance that is attractive to the pests as food source is deposited on the ground within the cavity formed by the hollow body. The food substance contains cellulose that is particularly attractive to termites. A lid is then positioned on the body to cover the open top. The system remains undisturbed for a period of time. Should the user detect consumption of the cellulose substance by the termites, the user substitutes the cellulose with bait that contains toxic material. As the bait is consumed the toxic material is carried into the subterranean colony, killing the colony.

In one of the preferred embodiments of the invention, the lid is locked with the body so as to protect the humans and pets from direct contact with the toxic substance. To this end, the hollow body carries a locking pin that extends through a bore formed in the lid. At least a portion of the pin has exterior threads that are engaged by a securing member above the lid. The securing member can be a wing nut or other suitable mechanical means.

### BRIEF DESCRIPTION OF THE DRAWINGS

Reference will now be made to the drawings, wherein like parts are designated by like numerals, and wherein

FIG. 1 is a perspective view of the pest control system of the present invention installed in site.

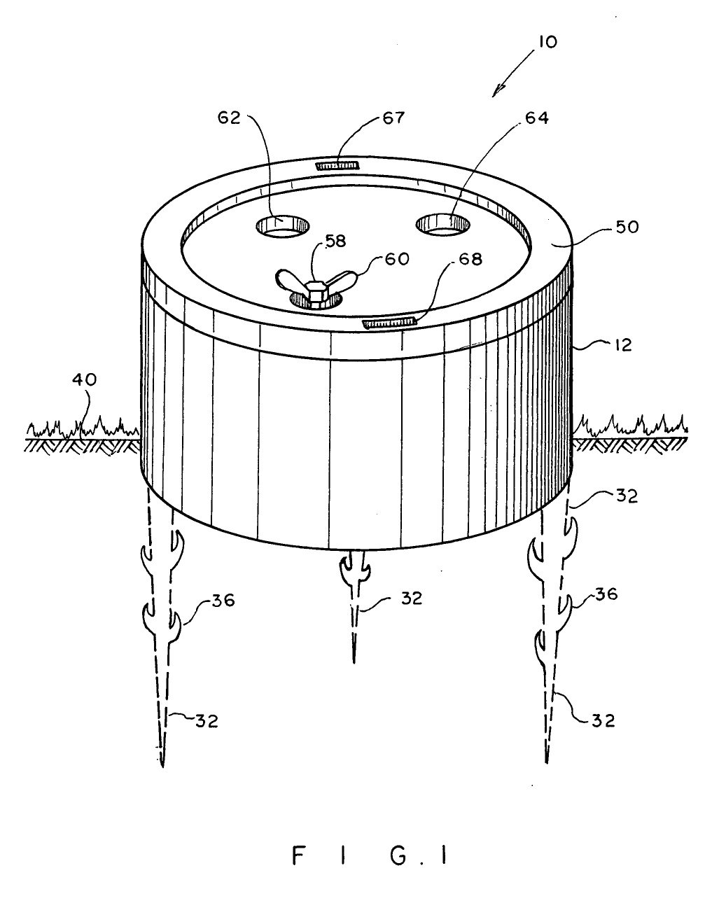

FIG. 2 is a side elevation of the pest control system of the present invention installed in site.

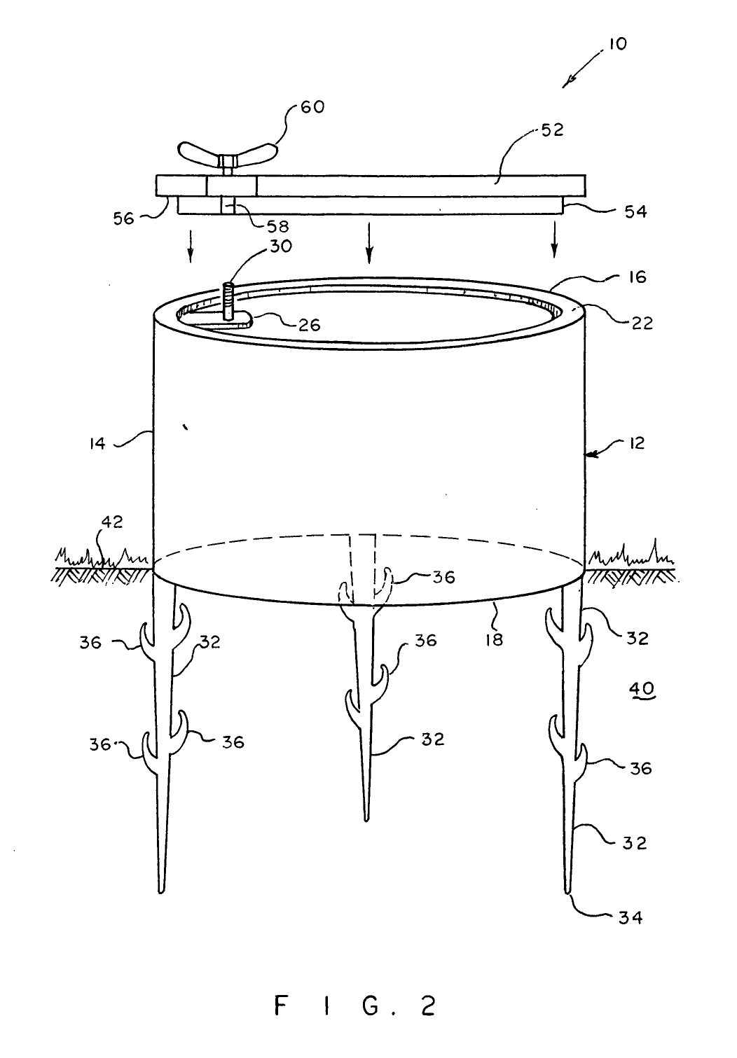

FIG. 3 is a sectional view of the pest control system, with the lid locked in place.

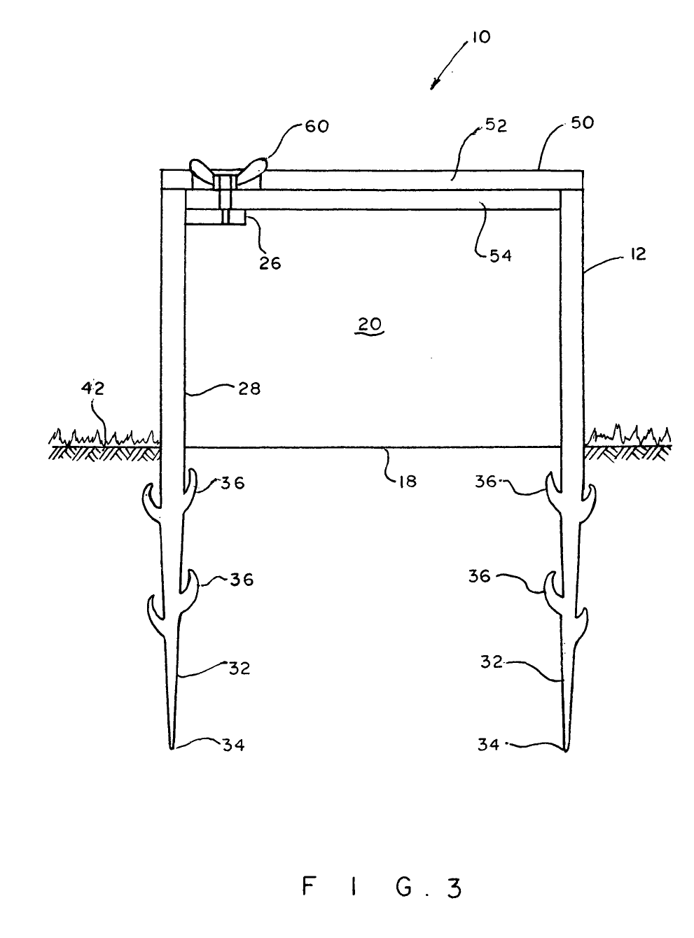

FIG. 4 is a plan view of the pest control system, with the lid removed.

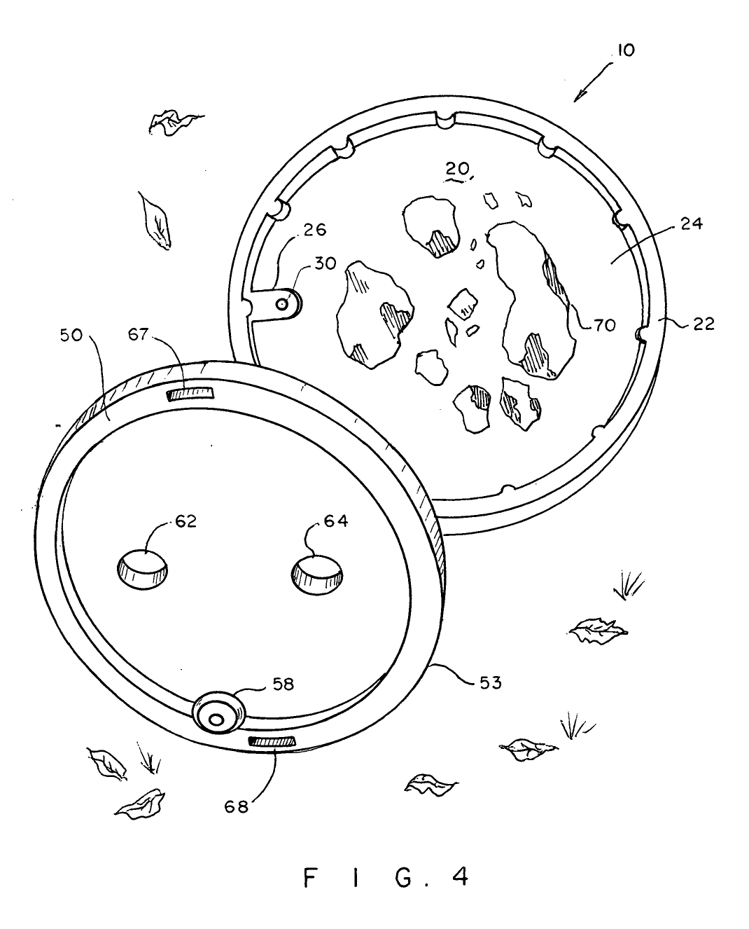

FIG. 5 illustrates the pest control system being installed by a user.

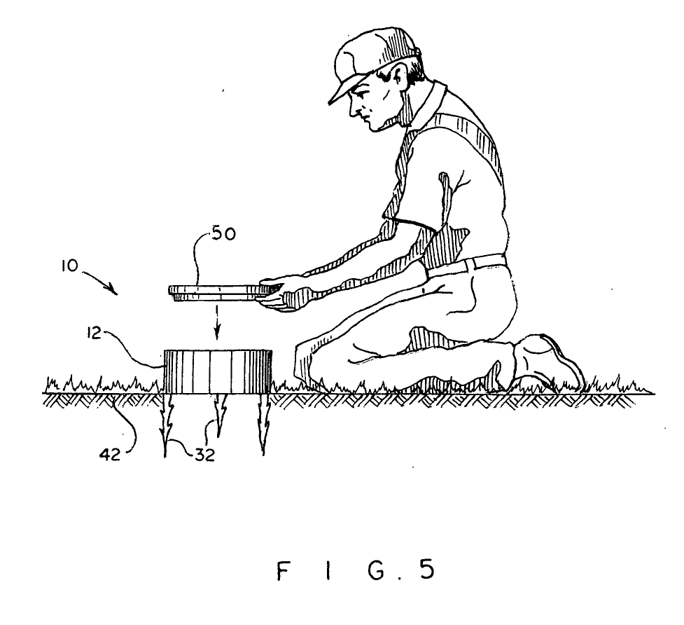

FIG. 6 is a top view of the pest control system, with the lid locked.

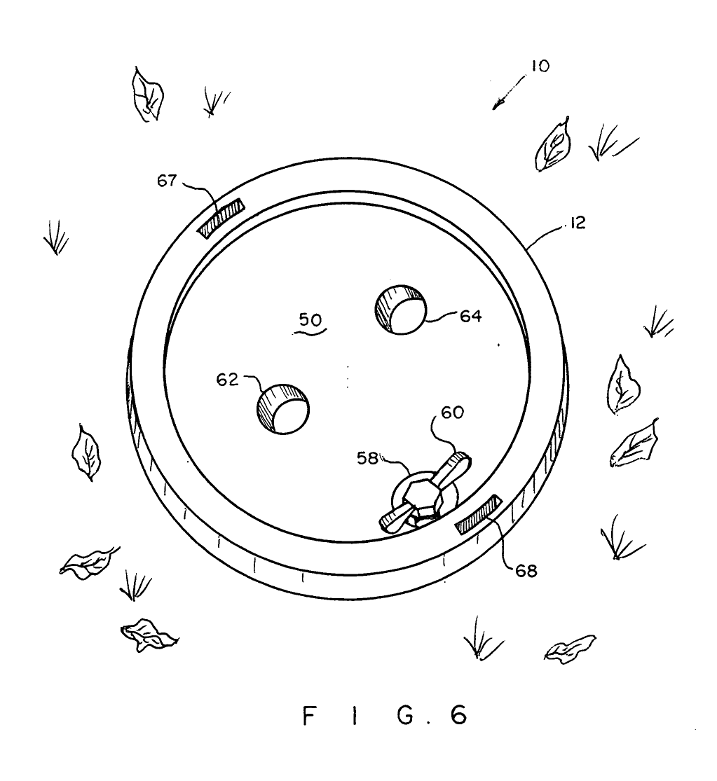

### DETAIL DESCRIPTION OF THE INVENTION

Turning now to the drawings in more detail, numeral 10 designates the pest control system of the present invention. It will be understood that the system 10 may be used to monitor and/or control other pests. The system 10 comprises a substantially hollow body 12 having a generally annular side wall 14, a top edge 16 and a bottom edge 18 defining an interior space 20 of the body 12. The body 12 has an open top and open bottom. An annular flange 22 extends inwardly from the top edge 16 restricting an upper opening 24. The annular flange 22 is secured to an inner wall 28 of the body 12.

A locking member 26 is secured to the inner wall 28 of the body 12 in a location below the annular flange 22, the locking member 26 extending inwardly toward the center of the interior space 20. A locking pin 30 extends upwardly from the locking member 26 in a direction substantially parallel to a longitudinal axis of the body 12. In one aspect of the invention, the locking pin 30 is formed by a bolt with exterior threads along at least a portion of its length.

A plurality of supporting legs 32 is secured equidistantly to the bottom edge 18. Each supporting leg 32 is formed as a spear with a sharply pointed end 34 and a plurality of barbs 36 extending backwards from the pointed end 34. As can be seen in the drawings, the barbs 36 extend upwardly securing the body 12 in the ground. The supporting legs 32 are configured to penetrate the soil 40 in a designated location where the presence of pests has been detected. In one aspect of the invention, the legs 32 are fixedly attached to the bottom edge 18 or unitary connected thereto. When the body 12 is positioned for operation, the legs 32 are embedded into the soil 40 such that the bottom edge 18 rests on the grade or ground level 42.

The system 10 further comprises a lid 50 configured for detachable engagement with the body 12. The lid 50 comprises a cover plate 52 and downwardly depending circular lip 54. The diameter of the lip 54 is slightly smaller than the diameter of the opening defined by flange 22, such that the lip 54 frictionally engages the flange 22 and the inner wall 28 when the lid 50 is locked with the body 12. The diameter of the cover plate 52 is at least equal to the diameter of the top edge 16, such that a bottom surface 56 of the cover plate 52 rests on the top edge 16 when the lid 50 is locked with the body 12. In one aspect, the body 12 and the lid 50 are formed from a non-corrosive material, for instance plastic.

A plurality of through openings is formed in the cover plate 52. A pin-receiving bore 58 is formed adjacent a circumferential edge 53 of the cover plate 52. The bore 58 is adapted to receive the locking pin 30 therethrough. A securing member, such as for instance a wing nut 60 can be threadably attached to the locking pin 30 thereby securing the lid 50 on the body 12 after the bore 58 is aligned with the locking pin 26.

The cover plate 52 is also provided with a pair of spaced apart finger-receiving openings 62, 64. The openings 62, 64 are configured to be engaged by the user's fingers allowing the user to lift the lid 50 from the body 12 and gain access to the interior space 20. At least one, or pair of slots 67, 68 is formed in the cover plate 52 adjacent the circumferential edge 53 of the cover plate 52. The slots 67, 68 can be rectangular or oval in shape. It is envisioned that the slots 67, 68 can be used for detaching the lid 50 from the body 12 should the user be unable to remove the lid 50 after grasping the lid using the finger-receiving openings 62, 64. The user can use a simple tool, for instance a screwdriver (not shown) to engage the slot 67 or 68 and lift the lid 50 from the body 12.

In operation, the body 12 is placed directly on the ground in a location where the presence of pests is detected or suspected. It is preferred that the soil has moisture content greater than 5% in the selected location. The user ensures that the legs 32 are embedded into the soil 40 such that the bottom edge 18 of the body 12 rests on the ground level 42. The legs 32 secure the station or system 10 on the ground, minimizing the chance of movement and making the cellulose material unmovable. The user then places cellulose-containing substance 70 into the interior space 20. The cellulose-containing substance is positioned directly on the ground 42. The lid 50 is then placed over the top opening of the body 12 and locked in place. In one aspect of the invention, it is preferred that the cellulose-containing substance 70 remain undisturbed for a period of about 30 days to give the foraging pests a chance to locate and feed on the cellulose.

After the feeding has begun, poisonous termite bait with active ingredients is added to the interior space 20. If the system 10 is used only for the purpose of monitoring the subterranean activity and detecting the presence of termites no toxic bait need to be added. If the user detects no activity in the system 10, the body 12 can be relocated to a new site. It is envisioned that the body 12 may also need to be relocated should the user detect presence of non-targeted insects, such as arthropods, annelids or mollusks.

Once the bait has been placed in the body 12, the termites feeding on the bait bring the bait to the nest when returning to their subterranean colony. As the toxic substance is consumed by termites, the bait with the cellulose substance is added to the interior space 20 for period of time for the bait to have the intended toxic effect on the colony. The system 10 is periodically inspected to determine whether termites are active within the system 10.

Depending on the activity and the speed of consumption of the cellulose-containing material and the bait, larger or smaller system 10 can be substituted in the selected location. If the cellulose-containing material is consumed within a matter of days a larger body 12 may be needed to hold larger quantity of cellulose-containing substance. The size of the body 12 can range from just a few inches in diameter to several feet in diameter. The large unit would be used possibly under a structure where the termite foraging pressure is very high and the colony size and age is greater than average, thus a larger quantity on cellulose would be needed to last 30 days. It is envisioned that the interval to be used as bait replacement period can be set by the pesticide regulatory bodies at 30 to 90 days.

One of the advantages of the system of the present invention is that it most closely mimics the way cellulose is found and consumed by subterranean termites under natural environmental conditions. The cellulose-containing material can be chips of wood, carton, paper, etc. it is placed directly on the ground surface, not below grade, thus attracting surface-foraging pests. The toxicant in the bait is preferably of the delayed-action type, or an insect growth regulator, pathogen or metabolic inhibitor. Preferably, it comprises a nontoxic cellulose-containing bait composition to which the pesticide toxicant is added. The removal, inspection and/or replacement of the lid 50 does not substantially disturb the network of access passageways established between the termite colony or nest and the system 10 since the body 12 is not displaced during removal and substitution of the cellulose-containing substance with the toxic bait.

Many changes and modifications can be made in the design of the present invention without departing from the spirit thereof. I, therefore pray that my rights to the present invention be limited only by the scope of the appended claims.

I claim:

1. A system for controlling subterranean pests in a pre-determined location, comprising:
a hollow body having an open top, an open bottom, a top edge, and a bottom edge defining an interior cavity, said interior cavity being adapted to receive a substance that is attractive and/or poisonous to the pests;
a plurality of supporting legs configured to be embedded into ground in the pre-determined location to a depth sufficient to position the bottom edge of the body at ground level;
a lid detachably engageable with the top edge of the body; and
a means for detachably securing the lid on said body.

2. The system of claim 1, wherein the hollow body comprises an inner wall and an annular flange extending along the inner wall below the top edge.

3. The system of claim 2, wherein the means for detachably securing the lid comprises a locking member attached to the inner wall below the annular flange and a locking pin is fixedly attached to the locking member and extending upwardly therefrom.

4. The system of claim 3, wherein said locking pin is provided with exterior threads.

5. The system of claim 4, wherein said lid is provided with a bore adapted to receive the locking pin therethrough.

6. The system of claim 5, wherein said means for detachably securing the lid further comprises a securing member detachably engageable with the locking pin above the lid.

7. The system of claim 6, wherein said securing member is a wing nut.

8. The system of claim 1, wherein each of said plurality of supporting legs comprises a spear-shaped member having a pointed lower end and a plurality of barbs secured on the spear shaped member.

9. The system of claim 8, wherein each of said plurality of barbs extending in a direction opposite to the pointed lower end.

10. The system of claim 1, wherein said lid is provided with spaced-apart openings configured to be engaged by user's fingers.

11. The system of claim 1, wherein said lid is provided with at least one slot configured to be engaged by a hand-held tool to allow the lid to be disengaged from the body.

12. The system of claim 2, wherein said lid is provided with a downwardly depending lip configured to rest on the annular flange when the lid is engaged with the body.

13. The system of claim 12, wherein said lid comprises a cover plate, said cover plate being configured to rest on the top edge when the lid is engaged with the body.

14. A system for controlling above-ground foraging subterranean termites in a pre-determined location, comprising:
a hollow body having an inner wall, an open top, an open bottom, a top edge, and a bottom edge defining an interior cavity, said interior cavity being adapted to receive a substance that is attractive and/or poisonous to the termites;
a plurality of supporting legs configured to be embedded into ground in the pre-determined location to a depth sufficient to position the bottom edge of the body at ground level;
a lid detachably engageable with the top edge of the body; and
a means for detachably securing the lid on said body, said securing means comprising a locking member attached to the inner wall, a locking pin extending upwardly from the locking member and a securing member configured to removably engage the locking pin above the lid.

15. The system of claim 14, wherein an annular flange is secured to the inner wall below the top edge, said lid is provided with a downwardly depending lip, and wherein the lip is configured to rest on the flange when the lid is engaged with the body.

16. The system of claim 15, wherein said lid comprises a cover plate, said cover plate being configured to rest on the top edge.

17. The system of claim 14, wherein the lid is provided with a through bore, said bore being adapted to receive the locking pin.

18. The system of claim 14, wherein the locking pin is provided with exterior threads, and said securing member is configured to threadably engage the locking pin.

19. The system of claim 18, wherein the locking pin is a wing nut.

20. The system of claim 14, wherein each of said plurality of supporting legs comprises a spear-shaped member having a pointed lower end and a plurality of barbs secured on the spear shaped member, said barbs extending in a direction opposite to the pointed lower end.

21. The system of claim 14, wherein said lid is provided with spaced-apart openings configured to be engaged by user's fingers.

22. The system of claim 14, wherein said lid is provided with at least one slot configured to be engaged by a hand-held tool to allow the lid to be disengaged from the body.

23. A method of monitoring and controlling subterranean pests in a pre-determined location, comprising the steps:
providing a hollow body having an inner wall, an open top, an open bottom, a top edge, and a bottom edge defining an interior cavity;
providing a plurality of supporting legs extending downwardly from the bottom edge of the body;
providing a lid configured to cover the open top of the body;
positioning the body in the predetermined location, while embedding the supporting legs into soil to a depth sufficient to position the bottom edge of the body at ground level;
depositing a substance attractive to the pests as food source in the cavity in direct contact with the ground;
covering the open top with the lid; and
allowing the substance attractive to the pests as food source to remain in the cavity, while monitoring consumption of said substance by the pests.

24. The method of claim 23, further comprising a step of detecting consumption of the substance attractive to the pests as food source within said cavity, thereby detecting presence of the pests in the predetermined location.

25. The method of claim 24, further comprising a step of substituting the substance attractive to the pests as food source by a bait substance containing material poisonous to the pests, and allowing the pests to consume the bait substance.

26. The method of claim 23, further comprising a means for detachably securing the lid on the body.

27. The method of claim 26, wherein said means for detachably securing the lid on the body comprises a locking member attached to the inner wall, a locking pin extending upwardly from the locking member and a securing member configured to removably engage the locking pin above the lid.

28. The method of claim 27, wherein an annular flange is secured to the inner wall below the top edge, said lid is provided with a downwardly depending lip, and wherein the lip is configured to rest on the flange when the lid is engaged with the body.

29. The method of claim 28, wherein said lid comprises a cover plate, said cover plate being configured to rest on the top edge.

30. The method of claim 27, wherein the lid is provided with a through bore, said bore being adapted to receive the locking pin.

31. The method of claim 27, wherein the locking pin is provided with exterior threads, and said securing member is configured to threadably engage the locking pin.

32. The method of claim 31, wherein the securing member is a wing nut.

33. The method of claim 23, wherein each of said plurality of supporting legs comprises a spear-shaped member having a pointed lower end and a plurality of barbs secured on the spear shaped member, said barbs extending in a direction opposite to the pointed lower end.

34. The method of claim 23, wherein said lid is provided with spaced-apart openings, and wherein the method comprises a step of removing the lid from the body by having a user position user's fingers in said openings and lifting the lid from the body.

35. The method of claim 23, wherein said lid is provided with at least one slot, and wherein the method comprises a step of removing the lid from the body by having a user engage said at least one slot by a hand-held tool and lifting the lid from the body.

36. The method of claim 23, wherein the step of allowing the substance attractive to the pests as food source to remain in the cavity for a predetermined period of time.

37. The method of claim 36, wherein the pre-determined period of time lasts for a period of between thirty and ninety days.

38. The method of claim 23, wherein said pests are above-ground foraging termites.

39. The method of claim 37, wherein the substance attractive to the pests as food source comprises cellulose material.
